(19) United States
(12) Patent Application Publication
(10) Pub. No.: US 2013/0085787 A1
(43) Pub. Date: Apr. 4, 2013

(54) METHOD OF MANAGING AN INSURANCE SCHEME AND A SYSTEM THEREFOR

(71) Applicants: Adrian Gore, Sandton (ZA); Barry Swartzberg, Sandton (ZA)

(72) Inventors: Adrian Gore, Sandton (ZA); Barry Swartzberg, Sandton (ZA)

(73) Assignee: DISCOVERY HOLDINGS LIMITED, Sandton (ZA)

(21) Appl. No.: 13/641,145

(22) PCT Filed: Apr. 13, 2011
(86) PCT No.: PCT/IB11/51603

§ 371 Date: Dec. 14, 2012

(30) Foreign Application Priority Data
Apr. 14, 2010 (ZA) 2010/02598
Jul. 28, 2010 (ZA) 2010/05379
Aug. 3, 2010 (ZA) 2010/05533
Feb. 16, 2011 (ZA) 2011/01241

(51) Int. Cl. G06Q 40/08

(52) U.S. Cl. CPC G06Q 40/08; G06Q 30/0207
USPC 705/4

(57) ABSTRACT

A method and system for managing an insurance scheme includes receiving and storing data relating to a life insurance agreement between an insured person and a life insurer including data relating to at least one premium to be paid to the life insurer and details of the life insurers obligations to the insured person or their beneficiary on the occurrence of the insured person dying or suffering disability. Receiving data including information relating to the compliance of the insured person in a plurality of programme areas related to motor vehicle driver behaviours and storing the data in a database. Points are awarded to the insured person wherein the points awarded are related to the compliance of the insured person in the programme areas and the points awarded are then used to determine a reward for the insured person from the life insurer.

### BACKGROUND OF THE INVENTION

The present invention relates to an insurance system.

In many countries motor vehicle accidents are a leading cause of death and disability. This impacts negatively on the amount of claims made to a life insurer and in return this impacts negatively on the premiums being paid by the insured person as the higher the claims on the life insurance scheme typically the higher the premiums for members of the scheme.

Various methods employed to motivate people to drive safely have been attempted but for one reason or another these always fail.

The present invention seeks to address this.

### SUMMARY

According to one example embodiment there is provided a method of managing an insurance scheme, the method including:
receiving and storing data relating to a life insurance agreement between an insured person and a life insurer including data relating to at least one premium to be paid to the life insurer and details of the life insurers obligations to the insured person or their beneficiary on the occurrence of the insured person dying or suffering disability;
receiving data including information relating to the compliance of the insured person in at least one programme areas related to motor vehicle driver behaviours and storing the data in a database;
awarding points to the insured person wherein the points awarded are related to the compliance of the insured person in the at least one programme areas; and
using the points awarded to determine a reward for the insured person from the life insurer.

The reward may take the form of at least one payment from the life insurer to the insured person.

Alternatively, the reward takes the form of at least one payment from the life insurer to a motor vehicle insurer that insures the motor vehicle thereby to reduce the amount that the insured person pays for their motor vehicle insurance.

The reward may be a periodic reward.

In one example embodiment, the reward is determined based on the amount of the at least one premium paid to the life insurer.

The points awarded may be used to determine a driver status, wherein the driver status is used to determine the reward for the driver.

The plurality of programme areas include at least some of vehicle maintenance, driver education, vehicle insurance claims and driving performance.

Alternatively, the plurality of programme areas include all of vehicle maintenance, driver education, vehicle insurance claims and driving performance.

The programme area of vehicle maintenance may include one or more of servicing the vehicle, checking the vehicle and checking the vehicles tires.

The programme area of driver education may include one or more of a driving course, a driver assessment, a periodic driver quiz and a carbon footprint calculation.

The programme area of vehicle insurance claims may include the number of claim free years.

In one example embodiment, the programme area of driving performance includes monitoring the manner in which a motor vehicle is driven.

In this example, the driver performance is measured by:
obtaining driver data from a device associated with a motor vehicle to be driven by the insured person;
analysing the driver data to determine the manner in which the motor vehicle has been driven for a past predetermined period; and
using the analysed driver data to determine the one more rewards for the insured person from the life insurer.

According to another example embodiment there is provided a system for managing an insurance scheme, the system including:
a database storing data relating to a life insurance agreement between an insured person and a life insurer including data relating to at least one premium to be paid to the life insurer and details of the life insurers obligations to the insured person or their beneficiary on the occurrence of the insured person dying or suffering disability;
a receiving module for receiving data relating to compliance of the insured person in at least one programme areas related to motor vehicle driver behaviours and storing the data in the database;
a calculation module for using the data to determine a reward for the insured person from the life insurer.

In one example embodiment, the calculation module uses the points awarded to determine a driver status, wherein the driver status is used to determine the reward for the driver.

The plurality of programme areas may include at least some of vehicle maintenance, driver education, vehicle insurance claims and driving performance.

Alternatively, the plurality of programme areas may include all of vehicle maintenance, driver education, vehicle insurance claims and driving performance.

The system may further determine driver performance wherein:
the receiving module obtains driver data from a device associated with a motor vehicle; and
the analysing module analyses the data to determine the manner in which the motor vehicle has been driven for a past period to determine driving performance.

The calculation module may calculate the reward periodically.

The calculation module may calculate the reward based on the amount of the at least one premium paid to the life insurer.

### BRIEF DESCRIPTION OF THE DRAWINGS

FIG. 1 illustrates an example system environment in which an embodiment is implemented;

FIG. 2 is a block diagram illustrating an example system to implement the methodologies described herein; and

FIG. 3 is a block diagram illustrating an example method implemented by the system.

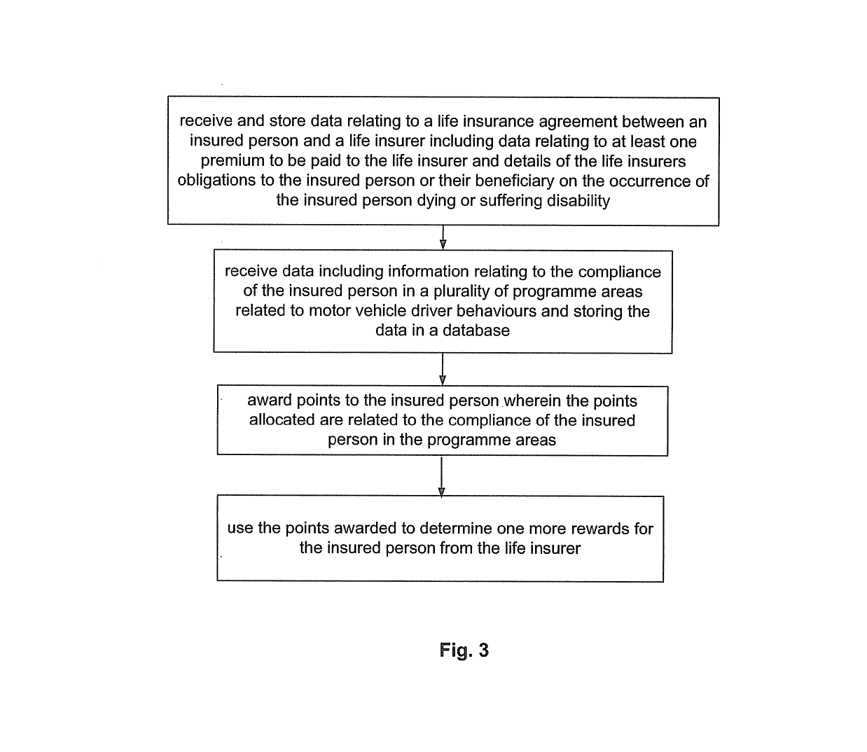

### DESCRIPTION OF EMBODIMENTS

The present invention relates to a system for managing an insurance scheme, particularly a so called life-insurance scheme.

An insurance scheme according to the present invention operates with an insured life paying a premium, typically a monthly premium, to a life insurer.

In return, the life insurer insures the insured life against the occurrence of an insured event such as dying, incurring a dread disease or suffering disability.

Clearly it is in the best interest of both the life insurer and the insured life for none of the insured events to occur. However, human nature has shown time and time again that people do not always look after themselves as they should.

A system according to the present invention is implemented to motivate the insured life to better driver behaviours thereby minimising their chances of having an accident.

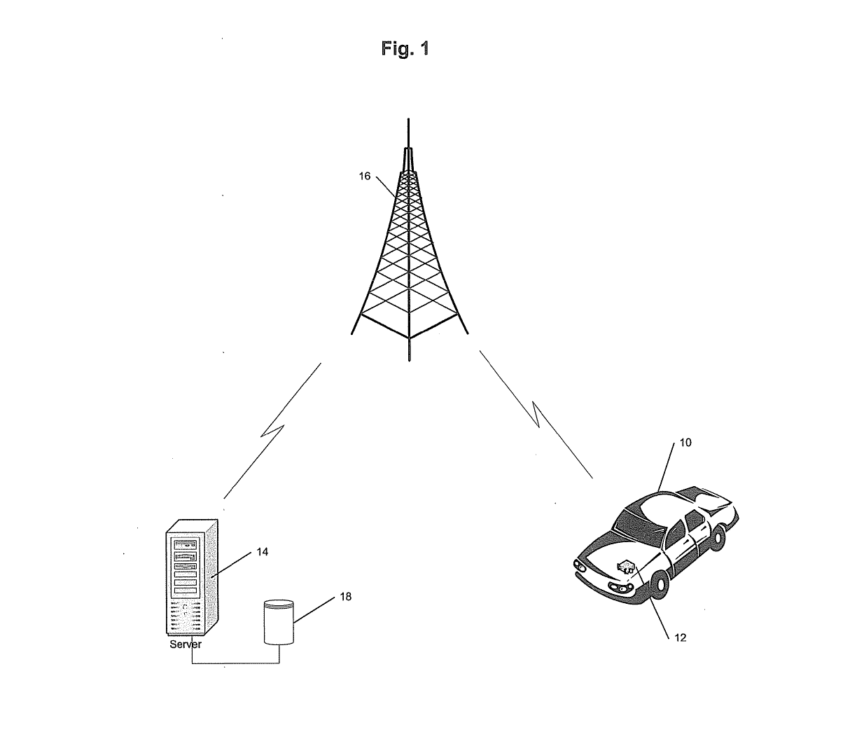

Referring to FIG. 1, a motor vehicle 10 which is to be driven by the insured life has a telemetry device 12 associated therewith. It will be appreciated that in one example the telemetry device 12 will be installed in the motor vehicle either at the time of production or retro-fitted.

The telemetry device 12 is used to monitor a number of aspects of the use of the motor vehicle.

For example, the device monitors the speed at which the vehicle is travelling and can therefore calculate average speed and maximum and minimum speeds, for example.

Where the device includes GPS functionality, for example, the device is able to determine if speed limits on a particular road have been exceeded.

The device is also able to determine braking habits of the driver either using the GPS functionality or by using an accelerometer or having one or more sensors connected to the vehicle or to a deceleration detection device, for example.

The device is also typically able to detect the distance travelled and if the driver has driven the vehicle for a long time period without a break.

In addition, the times of the day that the vehicle is being driven can be captured as night time driving is statistically more dangerous than day time driving, especially weekend late night driving.

In addition to the above, the device will have the ability to detect the driver's use of the vehicle including braking, indicating and accelerating to name a few examples. Thus it could be determined when the vehicle turns without indicating, for example.

In addition, the device has a driver identification module to identify the driver of the vehicle. This could take the form of a tag that is swiped past a tag reader wherein the tag contains a unique driver ID. Alternatively this could take the form of a biometrics reader such as a fingerprint scanner, for example.

In any event, the data from the device is transmitted to an information processing system over a communication network 16.

The information processing system could be managed by a life insurer, a short term insurer and/or a third party.

It will be appreciated that this could be accomplished in a number of ways. For example, the data could be transmitted via a communication network 16 as illustrated in the accompanying drawing. This communication network could be any suitable kind of communication network such as a mobile communication network, a wireless communication network, a satellite communication network or a combination of these to name but a few examples.

Alternatively, the device 12 could be connected to another intermediate device which downloads the data and transmits the data via the communication network 16 to the server 14. One example of this could be connecting the device 12 to a USB port of a computer and downloading the data to the computer, which data is then transmitted over the Internet to the information processing system including server 14.

In one example embodiment, the data is transmitted over a mobile telephone network using the short message service (SMS) protocol.

It will be appreciated that the data could be transmitted at any suitable time to the server. For example, the data could be transmitted in real time or near real time or could be transmitted periodically such as daily, weekly or monthly to name a few examples.

The data is received at the server 14 and stored in database 18 associated with the server.

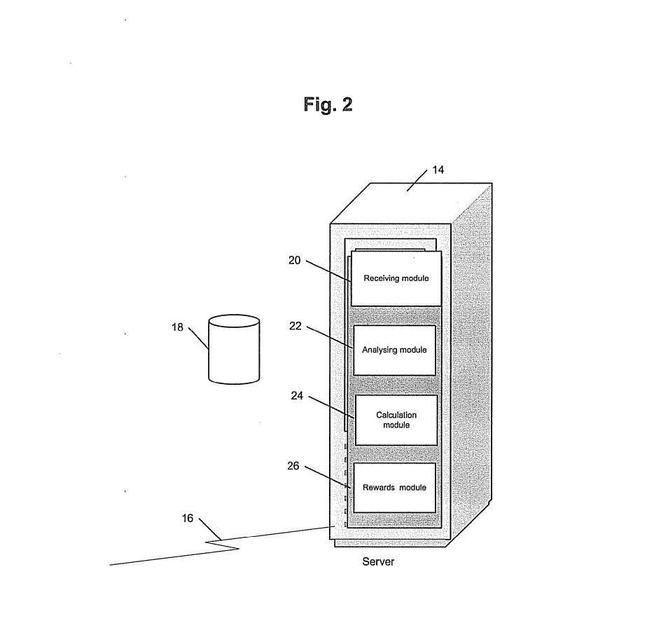

Referring to FIG. 2, the server 14 includes a number of modules to implement the present invention.

The server also includes a network adaptor (not shown) to communicate over at least one communication network.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 14 includes a receiving module 20 to receive the data and to write the data to a memory 18.

The memory 18 is typically in the form of a database 18 associated with the server 14.

In one example the data will include at least an identity of the insured person or an identification of the motor vehicle 10 or the device 12.

In the later two examples the identity of the insured person is pre-stored in the database 18 and using the identification of the motor vehicle 10 or the device 12 the identification of the insured person is retrieved.

Also stored in the memory 18 is data relating to a life insurance agreement between an insured person and a life insurer including data relating to at least one premium to be paid to the life insurer and details of the life insurers obligations to the insured person or their beneficiary for example on the occurrence of the insured person dying or suffering disability.

Finally, also stored in the memory 18 are details of a short term insurance policy taken out by the insured person on the motor vehicle 10 to which the telemetric device 12 is connected.

Once the server 14 receives the data it will analyse the data to determine the manner in which the motor vehicle has been driven for a past predetermined period.

To do this the server includes an analysing module 22 which accesses the memory 18 and retrieves the data stored therein.

The retrieved data is then used to calculate a number of factors depending on the requirements of the insurers.

For example, the data received from the device may include one or more of speed related data, time of day or night data indicating what time the vehicle is driven, duration information data relating to the duration of time that the vehicle is driven without the driver thereof taking a break and distance information data including the distance that the vehicle travels over a period of time such as a month.

The speed related data may include one or more of the average speed that the vehicle is driven and the number of times that the vehicle exceeds a speed limit on a road on which the vehicle is travelling.

The driver data is also analysed to determine mortality information meaning information relating to the likely mortality of the driver based on the way they drive.

A calculation module 24 uses the analysed data to determine one or more rewards for the insured person from the life insurer. This will be explained in more detail below.

A rewards module 26 is used to effect the award.

In one example embodiment, the data is analysed by the analysing module 22 and points are awarded to each of a number of sub-categories. Thus, points are awarded to the sub-category of speed which points are then used to determine an overall score. It will be appreciated that the scoring could be arranged that a higher score is a successful score or that a lower score is a successful score. In the illustrated embodiments described herein a higher score will be deemed a better score than a lower score.

Thus using the example of speed, the driver is awarded an amount of points if they never exceed the speed limit. Every infraction of the speed limit would result in a loss of points.

Similarly, for example, no night driving would result in a maximum score whilst a large amount of night driving would result in a zero or even a minus score.

The method may further include motivating the insured person to improve other driver related behaviours.

In this example embodiment, the receiving module 20 receives compliance data containing information relating to the compliance of a driver in at least one of a plurality of programme areas related to motor vehicle driver behaviour.

The compliance data is stored in the database 18.

The analysing module 22 analyses the compliance data to determine driver behaviour. This will be described in more detail below.

The calculation module 24 awards points to the driver wherein the points awarded are related to the compliance of the driver in one or more of the programme areas. An example of this is described below.

Finally, the points awarded are used by a rewards module 26 to determine a reward for the driver from the life insurer which will also be described in more detail below.

The plurality of programme areas includes at least some of vehicle maintenance, driver education, vehicle insurance claims, premium payments, policy updates and driving performance.

In one example embodiment, the plurality of programme areas includes all of the abovementioned programme areas.

The programme area of vehicle maintenance includes one or more of servicing the vehicle, checking the vehicle and checking the vehicles tires.

Describing these programme areas in more detail, servicing, the vehicle means that the driver has taken the vehicle to a mechanical workshop for a periodic service to ensure that the vehicle is in good working order. Typically in such services oil and other lubricants are changed, brake pads are changed if required and any other mechanical faults that have arisen in the past, period are fixed.

The programme area of checking the vehicle entails taking the vehicle to an authorised centre were a number of checks on the different parts of the vehicle are conducted to ensure that the vehicle is in good working order. If anything is found to be not correct, the vehicle will be taken to a workshop by the driver for fixing.

New vehicles may be exempt from the service check for the first year and the insured person will be awarded these points on submission of proof that the vehicle is within its first year since its first registration.

Checking the vehicle tires entails either having the tires checked as part of the above-mentioned checking of the vehicle or alternatively, taking the vehicle to a specialist tire centre to have the tires checked.

In one example embodiment, an interface is created between the server 14 and checking centre via the communications network 16 so that the checking centre can confirm the results of the check.

In addition to the tire check the steering, windscreen wipers, lights, seatbelts, hooter and shock absorbers can be checked at this time.

Bonus Points can be awarded for all of these being in an acceptable condition.

In all of these cases, the party doing the checking or servicing will capture data relating to the vehicle and/or driver and periodically transmit this data to the receiving module 20.

The programme area of driver education includes one or more of a driving course, a driver assessment, a periodic driver quiz and a carbon footprint calculation.

Driving courses are attended by drivers to improve their driving skills and particularly to learn so-called defensive driving skills.

A driver assessment is conducted in one example embodiment by an assessor taking the driver in the vehicle onto the road and assessing the driving skills and habits of the driver.

Weaknesses in the skills or habits of the driver may be pointed out and the driver given the opportunity to correct these in the coming weeks or months before returning for an updated assessment.

In one example, the driver is given an assessment score.

In another example, the driver assessment is an online questionnaire designed to highlight certain risks relating to a driver.

In this example, the questionnaire includes two sections namely. ‘Driving habits’ and ‘State of Vehicle’. For example a question of whether one uses a cellular telephone to send messages while driving will be asked. At the end of the questionnaire (approximately 20 questions) the driver will receive feedback explaining their risk and suggesting ways to mitigate their risks.

Based on the answers received a calculation will be performed to consider the driver's risk relative to an average driver. The results can be illustrated to the driver on two risk bars. One illustrates how risky the driver's habits are, and one illustrates risks relating to the state of the drivers vehicle.

A third risk bar may also be included illustrating a combined risk score.

In addition, the questionnaire may include educational information to address specific areas such as how to drive in wet weather or what to do in the event of an accident. The format will be a paragraph followed by a question relating to the paragraph

In this example, the driver will typically use a user interface device in the form of a computer with a screen on which is displayed a template for the driver to capture answers to questions put to them.

The answers are captured and transmitted to the server 14.

Alternatively, the server 14 accesses driver information stored in the database 18 and obtains the driver's e-mail address.

An e-mail is then sent to the retrieved e-mail address. When the driver opens the e-mail a template is displayed to them asking them the relevant questions with options to select various scores.

A driver will send the e-mail back to the server 14 via a communications network and the receiving module 20. These will be received and written to the database.

The programme area of premium payments relates to the quantum and frequency with which the premium payments are made and if they are made on time or not and the programme area of policy updates relates to whether or not the insured person is updating their policy to accurately reflect what is being insured by the insured person.

The programme area of vehicle insurance claims includes the number of claim free years on the motor vehicle insurance policy. No fault claims where the driver was not at fault typically will not be calculated as a claim for this.

The programme area of driving score includes monitoring the manner in which the motor vehicle is driven as has been described above.

An example of how the calculation module 24 then awards points is as follows:

| | Driver Category | Points | Frequency |
|---|---|---|---|
| Driving | No Star (no telematics device) | | Monthly |
| score | * | — | |
| | ** | 100 | |
| | *** | 350 | |
| | **** | 800 | |
| Road | Annual Service | 50 | Annual |
| worthy | Multi Point Check | 50 | |
| | Multi point check bonus points | 100 | |
| Education | Defensive driving course | 150 | Every 3 years |
| | Driver Assessment | 50 | Annual |
| | Quarterly quiz | 75 | ¼ly |
| | Carbon footprint calculated | 50 | Monthly |
| Claim | 1 | 25 | Monthly |
| Free | 2 | 50 | |
| Years | 3+ | 100 | |

It will be appreciated that the actual number of points awarded may change and other categories may be introduced.

In one example embodiment the number of points is used to determine a driver status. An example driver status is as follows:

Driver Status

| | |
|---|---|
| Red | 0 |
| Amber | 300 |
| Green | 600 |
| Double Green | 1000 |

It will be appreciated that the way in which the points are awarded and driver status determined could be varied. However, in an example embodiment the status will be determined periodically, for example every month.

At the beginning of every calendar month the driver's points are zeroed and drivers will then be awarded points for having done a multi point check, annual service, driver assessment or carbon footprint calculation within the previous 12 months.

Similarly quarterly quiz points will be awarded provided the questionnaire has been done for that quarter.

Defensive driving courses need to be completed every 3 years or any other specified period to earn points and if a defensive driving course has been completed in the past 3 years then the relevant points will be added to the driver score for the present month.

If confirmation of these point earning events are received midmonth then points will be awarded immediately therefore contributing to the driver status in that month.

On the last day of each month the driver's telematic data or a telematic score will be received and points award points accordingly.

If multiple vehicles are insured then one method of dealing with this is to use a weighted average to calculate a single score calculated.

This will complete the driver's points for the month which will be added together to get the driver status for that month.

The one or more rewards are then determined based on the driver status.

In one example embodiment the reward is a payback calculated, for example, as follows:

| | | | | Double | Triple |
|---|---|---|---|---|---|
| Life Insurance Premium | Red | Amber | Green | Green | Green |
| R200-R830 | 0 | 0 | 21 | 41 | 62 |
| Above R830 to R1 100 | 0 | 0 | 39 | 77 | 116 |
| Above R1 100 to R1 350 | 0 | 0 | 49 | 98 | 147 |
| Above R1 350 to R1 550 | 0 | 0 | 58 | 116 | 174 |
| Above R1 550 to R1 900 | 0 | 0 | 69 | 138 | 207 |
| Above R1 900 | 0 | 0 | 108 | 216 | 324 |

It will be appreciated that in this example embodiment the amount of the reward is dependent on the driver category but also on the amount of the life insurance premium that they are paying for their life insurance.

A rewards module 26 then effects the reward.

In one example embodiment this could be done by communicating with a financial institution via the communications network 16 and instructing the financial institution to implement the cash back by paying an amount into the insured life's bank account or onto their credit or debit card.

In another example, a retail reward may be implemented. One example of implementing a retail reward is that each driver will be eligible to apply for a credit card from a company associated with the rewards company.

This will entitle them to retail partner cash backs for spending at retail partners associated with the credit card company.

Another example would be to use a non-transactional card to capture retail spend and then refund the driver based on the retail spend captured by transferring funds into a bank account of the driver.

In another example embodiment the financial institution pays the funds over to a short term insurer which funds are then used to reduce the insurance premium payment on the motor vehicle that the insured person pays the short term insurer.

In order to implement this, the system instructs a financial institution to pay on an amount from the bank account of the life insurer to the bank account of the short term insurer. A data message with information detailing the amount transferred and details of whom it is transferred for is sent to a system of the short term insurer so that they are able to keep track of premiums owed to them by the insured person for the motor vehicle insurance.

Thus, effectively, the life insurer encourages the insured life to look after their driving by arranging a reduction on their short term insurance premium those hopefully having a positive impact on the number of claims to the life insurer.

In another example embodiment, the reward could be a reduced life insurance premium payable to the life insurer in a future period for the life insurance policy of the driver.

Alternatively or in addition, the reward could be an increase in the amount of life/disability cover for good driver behaviours.

Alternatively or in addition the reward could be a fuel related reward whereby the driver obtains either an amount of fuel, a discount on a future fuel purchase, or a refund on a past fuel purchase as a reward.

1-26. (canceled)

27. A method of managing an insurance scheme, the method including:
receiving and storing data, with a computer, relating to a life insurance agreement between an insured person and a life insurer including data relating to at least one premium to be paid to the life insurer and details of the life insurers obligations to the insured person or their beneficiary on the occurrence of the insured person dying or suffering disability;
receiving data, with the computer, including information relating to compliance of the insured person in at least one programme area related to motor vehicle driver behaviours and storing the data in a computer database;
awarding points to the insured person wherein the points awarded are calculated by the computer and are related to the compliance of the insured person in the at least one programme area; and
using the points awarded to determine with the computer a reward for the insured person from the life insurer.

28. A method according to claim 27 wherein the reward takes the form of at least one payment from the life insurer to the insured person.

29. A method according to claim 27 wherein the reward takes the form of at least one payment from the life insurer to a motor vehicle insurer that insures the motor vehicle thereby to reduce the amount that the insured person pays for their motor vehicle insurance.

30. A method according to claim 27 wherein the reward is a periodic reward.

31. A method according to claim 27 wherein the reward is determined based on the amount of the at least one premium paid to the life insurer.

32. A method according to claim 27 wherein the points awarded are used to determine a driver status, wherein the driver status is used to determine the reward for the driver.

33. A method according to claim 27 wherein the plurality of programme areas include at least some of vehicle maintenance, driver education, vehicle insurance claims and driving performance.

34. A method according claim 27 wherein the plurality of programme areas include all of vehicle maintenance, driver education, vehicle insurance claims and driving performance.

35. A method according to claim 33 wherein the programme area of vehicle maintenance includes one or more of servicing the vehicle, checking the vehicle and checking the vehicles tires.

36. A method according to claim 33 wherein the programme area of driver education includes one or more of a driving course, a driver assessment, a periodic driver quiz and a carbon footprint calculation.

37. A method according to claim 33 wherein the programme area of vehicle insurance claims includes the number of claim free years.

38. A method according to claim 33 wherein the programme area of driving performance includes monitoring the manner in which a motor vehicle is driven.

39. A method according to claim 33 wherein the programme area of driver performance is measured by:
obtaining driver data from a device associated with a motor vehicle to be driven by the insured person;
analysing the driver data with the computer to determine the manner in which the motor vehicle has been driven for a past predetermined period; and
using the analysed driver data to determine with the computer the one more rewards for the insured person from the life insurer.

40. A computer system for managing an insurance scheme, the computer system including:
a database storing data relating to a life insurance agreement between an insured person and a life insurer including data relating to at least one premium to be paid to the life insurer and details of the life insurers obligations to the insured person or their beneficiary on the occurrence of the insured person dying or suffering disability;
a receiving module for receiving data relating to compliance of the insured person in at least one programme area related to motor vehicle driver behaviours and storing the data in the database;
a calculation module for using the data to determine a reward for the insured person from the life insurer.

41. A computer system according to claim 40 wherein the calculation module uses the points awarded to determine a driver status, wherein the driver status is used to determine the reward for the driver.

42. A computer system according to claim 40 wherein the plurality of programme areas include at least some of vehicle maintenance, driver education, vehicle insurance claims and driving performance.

43. A computer system according to claim 40 wherein the plurality of programme areas include all of vehicle maintenance, driver education, vehicle insurance claims and driving performance.

44. A computer system according to claim 42 wherein the programme area of vehicle maintenance includes one or more of servicing the vehicle, checking the vehicle and checking the vehicles tires.

45. A computer system according to claim 42 wherein the programme area of driver education includes one or more of a driving course, a driver assessment, a periodic driver quiz and a carbon footprint calculation.

46. A computer system according to claims 42 wherein the programme area of vehicle insurance claims includes the number of claim free years.

47. A computer system according to claim 42 wherein the programme area of driving score includes monitoring the manner in which the motor vehicle is driven.

48. A computer system according to claim 42 further wherein:
the receiving module obtains driver data from a device associated with a motor vehicle; and
the analysing module analyses the data to determine the manner in which the motor vehicle has been driven for a past period to determine driving performance.

49. A computer system claim 40 wherein the reward takes the form of at least one payment from the life insurer to the insured person.

50. A computer system according to claim 40 wherein the reward takes the form of at least one payment from the life insurer to a motor vehicle insurer that insures the motor vehicle thereby to reduce the amount that the insured person pays for their motor vehicle insurance.

51. A computer system according to claim 40 wherein the calculation module calculates a reward periodically.

52. A computer system according to claim 40 wherein the calculation module calculates the reward based on the amount of the at least one premium paid to the life insurer.
